(19) United States
(12) Patent Application Publication
(10) Pub. No.: US 2025/0329258 A1
(43) Pub. Date: Oct. 23, 2025

(54) CONNECTIVITY AND MACHINE LEARNING BASED OPTIMIZATION OF FREIGHT DELIVERY VEHICLE FLEETS

(71) Applicant: Cummins Inc., Columbus, IN (US)

(72) Inventors: Hoseinali Borhan, Bloomington, IN (US); Jairo Andres Sandoval Leon, Columbus, IN (US); Scott Moura, Berkeley, CA (US); Robert Ciprian Radulescu, Greenville, SC (US); Aashrith Vishwanath, Columbus, IN (US)

(21) Appl. No.: 18/336,122

(22) Filed: Jun. 16, 2023

Related U.S. Application Data
(60) Provisional application No. 63/366,475, filed on Jun. 16, 2022.

(51) Int. Cl. G08G 1/00; G01C 21/34

(52) U.S. Cl. CPC G08G 1/20; G01C 21/3469

(57) ABSTRACT

A method of operating a fleet optimization system to optimize operation of a fleet of vehicles is provided. The method includes determining a dispatch and routing plan for a fleet of vehicles, and providing the dispatch and routing plan to a fleet management system. The method includes receiving feedback parameters indicating energy/fuel consumption of the fleet operating according to the dispatch and routing plan, and further determining an energy consumption probability distribution for the fleet in response to the feedback parameters. Using the energy consumption probability distribution, the method determines an updated dispatch and routing plan for the fleet of vehicles to optimize delivery and energy consumption objectives.

### CROSS REFERENCE

The present disclosure claims priority to and the benefit of U.S. Application No. 63/366,475 filed Jun. 16, 2023 and the same is hereby incorporated by reference.

### GOVERNMENT LICENSE RIGHTS

This invention was made with government support under contract no. DE-EE0009206 awarded by the U.S. Department of Energy. The government has certain rights in the invention.

### TECHNICAL FIELD

The present disclosure relates generally to management and optimization of fleets of freight delivery vehicles and, more particularly, but not exclusively, to freight delivery vehicle fleet optimization including connectivity-based and machine learning-based techniques.

### BACKGROUND

A number of efforts have been made to manage and optimize operation of freight delivery vehicle fleets. While offering some benefits, existing approaches suffer from a number of challenges, drawbacks, shortcomings, and unsolved problems. Therefore, there remains a significant need for the apparatuses, methods, and systems disclosed herein.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention includes and protects such alterations, modifications, and further applications of the example embodiments as would occur to one skilled in the art.

### SUMMARY OF THE DISCLOSURE

One embodiment is a unique process of managing or optimizing freight delivery vehicle fleets. A further embodiment is a unique system for managing or optimizing freight delivery vehicle fleets. Further embodiments, forms, objects, features, advantages, aspects, and benefits shall become apparent from the following description and drawings.

### BRIEF DESCRIPTION OF THE DRAWINGS

FIG. 1 is a schematic illustration of certain aspects of an example optimization system.

FIG. 2 is a flow diagram depicting certain aspects of an example optimization procedure.

FIG. 3 is a flow diagram depicting certain aspects of an example optimization procedure.

FIG. 4 is a flow diagram depicting certain aspects of an example optimization procedure.

FIG. 5 is a schematic illustration of certain aspects of an example stochastic probability optimization.

### DETAILED DESCRIPTION OF EXAMPLE EMBODIMENTS

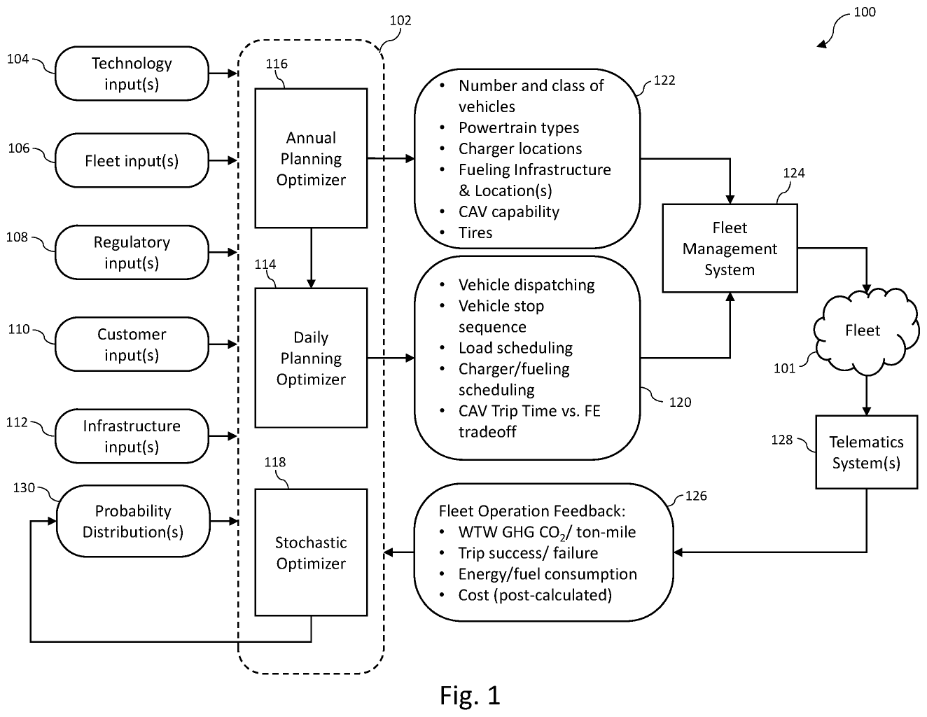

With reference to FIG. 1, there is illustrated an example system 100 for operating and managing a fleet 101 including a plurality of vehicles. In FIG. 1, system 100 includes a fleet optimization network 102 which may be configured to perform an optimization of a fleet of vehicles according to a number of optimization objectives. The optimization objectives may include any one or more freight delivery objectives (e.g., destinations and timings), energy/fuel consumption objectives (e.g., fuel consumption, energy consumption, fuel efficiency, well-to-wheel greenhouse gas (“WTW GHG”) emissions, or combinations of the foregoing and/or other energy/fuel consumption metrics or proxies), fleet cost objectives (e.g., total cost of ownership and/or operation of the fleet), or other objectives as will occur to one of skill in the art with the benefit and insight of the present disclosure.

It shall be appreciated that W2W GHG emissions may be denominated in terms of tons of CO₂ emissions, equivalent tons of tons of CO₂ emissions (accounting for variation in the effects of other GHG), in other denominations, and that the tons (or other mass units may be normalized per mile or per other unit distance). It shall also be appreciated that the term “energy/fuel” refers to energy and/or fuel. Thus, for example, “energy/fuel consumption” encompasses consumption of one or both of fuel and other energy sources such as the examples described herein. Similarly, “energy/fuel consumption objectives” encompass objectives for consumption of one or both of fuel and other energy sources such as the examples described herein. Likewise, “energy/fuel efficiency” encompasses the efficiency with which of one or both of fuel and other energy sources such as the examples described herein are consumed or utilized. Use of the term “energy/fuel” to refer to and encompass “energy and/or fuel” further applies to other instances and usages herein.

In some embodiments, the optimization objectives of optimization network 102 may include a combination of freight delivery objectives and energy/fuel consumption objectives. In some embodiments, the optimization objectives of optimization network 102 may include a combination of freight delivery objectives and total fleet cost objectives. In some embodiments, the optimization objectives of optimization network 102 may include a combination of energy/fuel consumption objectives and total fleet cost objectives. In some embodiments, the optimization objectives of optimization network 102 may include a combination of freight delivery objectives, energy/fuel consumption objectives, and total fleet cost objectives. In some embodiments, the optimization objectives of optimization network 102 may include CO₂ or GHG emissions reduction targets such as WTW GHG emissions reduction targets. In any of the foregoing embodiments, the objectives may consist essentially of the explicitly stated objectives, or may comprise the explicitly stated objectives and optionally one or more other objectives and or constraints.

Optimization network 102 may receive a plurality of inputs including, for example, technology inputs 104, fleet inputs 106, regulatory inputs 108, customer inputs 110, and infrastructure inputs 112. Technology inputs 104 may comprise information as to the availability and performance of different types of vehicles and different types of vehicle powertrains such as internal combustion engine vehicles, hybrid vehicles, battery electric vehicles, and fuel cell electric vehicles. Technology inputs 104 may comprise information such as prices and WTW GHG emissions of one or more energy sources which may be utilized by various types of powertrains, such as combustible or consumable fuels (e.g., diesel, gasoline, natural gas, ethanol or other alcohols, and hydrogen) or a number of sources of electricity, for example, grid electricity or dedicated or islanded source electricity (e.g., from a dedicated photo-voltaic solar installation).

Fleet inputs 106 may include a number of parameters determined or specified by a fleet owner or operator. Such parameters may include, for example, fleet depot locations, fleet depot hours, driver preferences, budgets, customer cost or charge information (e.g., cost-per-mile to be charged to one or more customers), duration of ownership targets, different types of powertrains, and other parameters as will occur to one of skill in the art with the benefit and insight of the present disclosure. The regulatory inputs 108 may include driver operation hours including the number of hours the driver is permitted to operate or drive the vehicle.

Regulatory inputs 108 include a number of parameters determined or specified by a governmental or regulatory authority. Such parameters may include, for example, WTW GHG emissions limits or targets, driver limits (e.g., limits on the time per day that the driver may drive), speed limits, vehicle weight and load limits, and other parameters as will occur to one of skill in the art with the benefit and insight of the present disclosure.

Customer inputs 110 may include a number of parameters determined or specified by a fleet owner or operator, or by customers of a fleet owner or operator. Such parameters may include, for example, expected demand for a short-term planning period (e.g., one or more days or day portions), expected demand for over a longer-term planning period (e.g., one or more months, quarters, or years), and other parameters as will occur to one of skill in the art with the benefit and insight of the present disclosure.

Infrastructure inputs 112 may include a number of parameters indicative of energy and infrastructure resources available over a fleet operation area. Such parameters may include, for example, location, operating hours, and price information for fueling stations for conventional fuels, electric charging stations, and fueling stations for hydrogen or other alternative fuels.

Optimization network 102 may be configured and operable to perform optimization procedures according to the present disclosure. Optimization network 102 may be configured and provided with one or more processors in operative communication with each other and configured to execute optimization instructions. Optimization network 102 may be provided in a number of configurations, forms, and implementations including, for example, as one or more cloud computing systems, data centers, desktops, industrial computers, laptops, servers, tablets, workstations, combinations thereof, or other configurations, forms, and implementations as will occur to one of skill in the art with the benefit and insight of the present disclosure. Thus, it shall be appreciated that the components and operations of optimization network 102 may be distributed across or among multiple computing devices in operative communication with one another over various communication links.

System 100 includes a fleet management system 124 which is configured to receive a dispatch and routing plan 120 and a fleet resource plan 122 from optimization network 102 and manage operation of a fleet 101 comprising a plurality of vehicles. In some embodiments, optimization network 102 receives fleet operation feedback information 126 indicating operational performance of fleet 101. The fleet operation feedback information 126 may be provided via one or more vehicle telematics systems 128. Other systems, techniques, or data loggers may be contemplated to provide fleet operation feedback information. In some embodiments, the fleet operation feedback information 126 may include feedback parameters indicating route travel parameters of the fleet 101 operating according to the dispatch and routing plan. The route travel parameters of fleet 101 may include actual routes traveled by vehicles of the fleet 101, an indication of success or failure of missions corresponding to the actual routes traveled, WTW GHG emissions information for each vehicle, energy/fuel consumption information, and cost of trip information.

In the illustrated embodiment, optimization network 102 is configured as a multi-level optimization network with at least two optimizers working in conjunction to perform optimization. In the illustrated multi-level form, optimization network 102 includes dispatch and routing plan optimizer 114 (also referred to herein as optimizer 114) which is configured to determine an optimized dispatch and routing plan for the fleet over a first time range. The first time range may, for example, provide for optimizations over a daily or partial-daily basis or range.

The optimized dispatch and routing plan 120 which is determined by dispatch and Optimizer 114 may include, for example, one or more routes, stop sequence(s) for the one or more routes, vehicle dispatching for the one or more routes (e.g., selection of a vehicle or vehicles for a given route), scheduling of vehicle loading, scheduling of vehicle fueling and/or charging. The optimized dispatch and routing plan 120 is provided to fleet management system 124 and may be utilized in controlling operation of a fleet of vehicles.

Optimizer 114 may be provided in the form of a machine learning-based model predictive controller or a controller configured with a mixed-integer-programing formulation which utilizes feedback indicating actual performance of a vehicle fleet operating according to optimized parameters of dispatch and routing plan 120 which were determined by optimizer 114 and provided to a fleet management system 124. In the illustrated embodiment, feedback 126 is provided from vehicles in a vehicle fleet via one or more telematics systems 128 and may include a number of feedback parameters including, for example, WTW GHG emissions tons/mile, trip success or failure, trip delays or routing changes, fuel or energy/fuel consumption, and operational cost, which may be post-calculated rather than being determined on-board vehicles of the fleet.

Optimizer 114 may be configured to optimize an objective function including a plurality of objectives including delivery objectives and energy/fuel consumption objectives. The delivery objectives may include trip time parameters (e.g., total trip time, timing of one or more deliveries of a trip, delivery destination priorities, and/or other delivery objective metrics or proxies). In some embodiments, the delivery objectives may include connected automated vehicle (CAV) trip time which may have objectives of minimizing trip time and maximizing CAV operation time during a trip.

The energy/fuel consumption objectives may include a number of objective parameters, for example, fuel consumption, energy consumption, fuel efficiency, WTW GHG emissions, or combinations of the foregoing and/or other energy/fuel consumption metrics or proxies). In some embodiments the plurality of objectives may include or consider a co-optimization, balancing, or trade-off between delivery objectives and energy/fuel consumption objectives, for example, a tradeoff between trip time (e.g., CAV trip time) and fuel efficiency.

The optimization of the objective function by optimizer 114 may utilize one or more probability distributions relevant to the optimization objectives, for example, fuel consumption, energy consumption, energy/fuel efficiency, WTW GHG emissions, operating cost, or combinations of the foregoing for the vehicles of the fleet. Such probability distributions may be initially provided as empirically based, estimated, or nominal probability distributions and may thereafter be updated and modified in response to feedback such as feedback 126.

In the illustrated multi-level form, optimization network 102 includes fleet resource plan optimizer 116 (also referred to herein as optimizer 116) which is configured to determine a fleet resource plan 122 for the fleet over a second time range which is greater than the first time range over which optimizer 114 operates. The second time range may, for example, provide for optimizations over a monthly, quarterly, annual basis, or longer basis or range.

The fleet resource plan 122 which is determined by optimizer 116 may include, for example, a number and class of vehicles in the fleet, powertrain types and attributes of the vehicles, electric charger locations, CAV capabilities of fleet vehicles, and vehicle tire selections.

Optimizer 116 may be provided in the form of a machine learning-based model predictive controller or a mixed-integer-programing formulation which utilizes feedback indicating actual performance of a vehicle fleet according to fleet resource plan 122 which was determined by optimizer 116 and provided to a fleet management system 124. In the illustrated embodiment, feedback 126 is provided from vehicles in a vehicle fleet via one or more telematics systems 128 and may include a number of feedback parameters. Such feedback parameters may include vehicle energy use parameters, for example, WTW GHG emissions, trip success or failure, trip delays or routing changes, energy/fuel consumption, and operational cost, which may be post-calculated rather than being determined on-board vehicles of the fleet. Feedback 126 may be stored and aggregated over the second time range, a substantial portion thereof, or over a longer range such that optimizer 116 is learning from data commensurate with the second time range over which it operates.

Optimizer 116 may be configured to optimize an objective function including one or more fleet cost objectives, for example, total cost of ownership, vehicle cost, and/or cost of operation of the fleet. The optimization of the objective function by optimizer 116 may utilize one or more probability distributions relevant to the optimization objectives, for example, vehicle cost and vehicle operating cost for the vehicles of the fleet. Such probability distributions may be initially provided as empirically based, estimated, or nominal probability distributions and may thereafter be updated and modified in response to feedback such as feedback 126.

Optimization network 102 further includes stochastic optimizer 118 which is configured to determine updates to or modifications of one or more probability distributions 130 which, in turn, are provided to components of fleet optimization network 102 including optimizer 114 and optimizer 116, first in initial form and later in updated or modified form. The probability distributions may comprise one or more optimized energy/fuel consumption, vehicle range, and/or cost probability distributions 130 for the fleet. The energy/fuel consumption distribution(s) may define the distribution of and frequency of predicted energy/fuel consumption for a fleet comprising a plurality of vehicles, for example, fuel consumption, energy/fuel consumption, fuel efficiency, WTW GHG emissions, or combinations of the foregoing and/or other energy/fuel consumption metrics or proxies for the vehicles. Such a distribution may be visualized or plotted on a graph with a number of vehicles on its vertical axis and variation in an energy/fuel consumption metric or proxy on its horizontal axis with the distribution being defined by a curve or shape resulting from plotting points on such a graph.

The fleet cost distribution may reflect the distribution of and frequency of predicted vehicle operating costs for a plurality of vehicles of the fleet, for example, total cost of ownership, fleet operating costs, or other objectives as will occur to one of skill in the art with the benefit and insight of the present disclosure. Such a distribution may be visualized or plotted on a graph with the number of vehicles on its vertical axis and variation in a fleet cost objective metric or proxy on its horizontal axis with the distribution being defined or represented by an area under a curve or shape resulting from plotting points on such a graph.

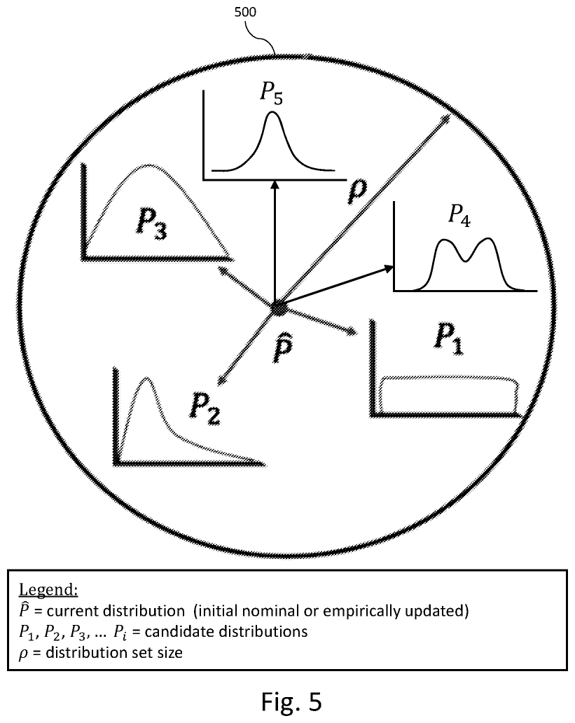

The configuration and operation of stochastic optimizer 118 are further described with respect to FIG. 5 which depicts certain aspects of an example stochastic probability optimization that may be performed in a distribution ambiguity set 500 which is one example of a probability distribution space containing a current distribution (\hat{P}) and a plurality of candidate distributions (P₁, P₂, P₃, . . . . Pᵢ) to or toward which the current distribution (\hat{P}) can be modified or updated. In the illustrated example ambiguity set 500 has a size (ρ) which may be selected to provide a degree or scope of distribution variation suitable for accommodating modification or updating of the current distribution (\hat{P}) in response to empirical feedback.

Stochastic optimizer 118 may be configured to receive feedback parameters such as feedback parameters 126 and to update the one or more energy/fuel consumption and/or cost probability distributions in response to the feedback parameters. In some embodiments, stochastic optimizer 118 may be configured and operable to minimize an error between current distribution (\hat{P}) and distribution information contained in (or determinable using) feedback parameters 126. For example, distribution ambiguity set 500 may evaluate which, if any, of the plurality of candidate distributions (P₁, P₂, P₃, P₄, . . . . Pᵢ) minimizes such error or better conforms to distribution information contained in (or determinable using) feedback parameters 126. Current distribution (\hat{P}) may be initially set to a default or initial value, such as a normal distribution or another distribution which may be selected based on empirical data or theoretical models or formulae. Thereafter, when updated or modified, current distribution (\hat{P}) may be set as another defined distribution, such as a flat or substantially flat distribution (e.g., P₁), a Poisson distribution (e.g., P₂), a truncated normal distribution (e.g., P₃), a bimodal distribution (e.g., P₄), a fat-tailed normal distribution (e.g., P₅), or any of a variety of other distributions as will occur to one of skill in the art with the benefit and insight of the present disclosure. In some embodiments, the updating or modification of current distribution (\hat{P}) may involve interpolation between the current distribution (\hat{P}) and another distribution of the distribution ambiguity set 500.

As indicated above, resource plan optimizer 116 and/or dispatch and routing plan optimizer 114 may be configured to take account of the one or more energy/fuel consumption and/or cost probability distributions and uncertainties. Likewise, stochastic optimizer 118 may be configured to inform fleet resource plan optimizer 116 and/or dispatch and routing plan optimizer 114 of the updated parameters. Henceforth, optimizer 114 and optimizer 116 use this information to enhance their robustness and accuracy.

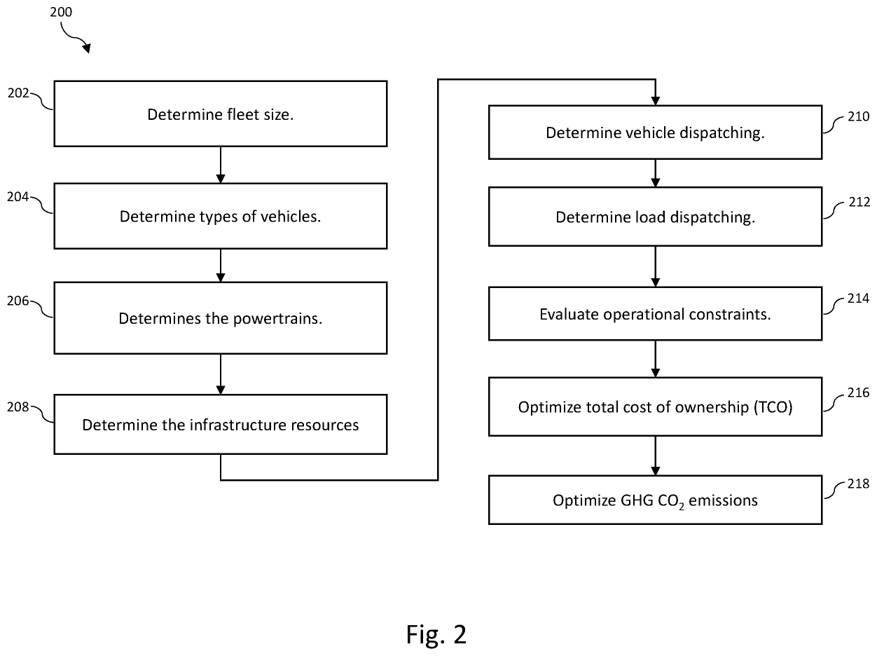

With reference to FIG. 2, there is illustrated an example method 200 which may be implemented, executed, or performed by fleet resource plan optimizer 116 to determine an optimized fleet resource plan. Method 200 may begin at operation 202 which determines an optimization of fleet size. For example, optimizer 116 may determine how many vehicles are needed in fleet 101.

From operation 202, method 200 proceeds to operation 204 which determines an optimization of types of vehicles in fleet 101. For example, optimizer 116 may determine vehicle class (e.g., class 8, class 6, etc.) and vehicle types (e.g., line haul vs. regional haul).

From operation 204, method 200 includes operation 206 to determine an optimization of types of powertrains for fleet 101. The powertrains may include, but are not limited to, diesel, gasoline, CNG, electric, plug-in, or fuel cell. Determining the types of powertrains may also include determining vehicle power, size of a battery pack, and size of a fuel tank, among others.

From operation 206, method 200 proceeds to operation 208 which determines an optimization of fleet infrastructure, for example, determining hydrogen or natural gas fueling stations and electric charging stations, among others available to or to be added to a fleet.

From operation 208, method 200 proceeds to operation 210 which determines an optimization of vehicle scheduling. For example, the optimizer 116 may determine which vehicles need to be sent on which routes, the order of the routes for each vehicle, and the timing.

From operation 210, method 200 proceeds to operation 212 which determines load dispatching. For example, operation 212 may determine how much load needs to be on each vehicle.

From operation 212, method 200 proceeds to operation 214 which evaluates whether the foregoing optimizations meet one or more operational constraints. If one or more constraints on one or more optimizations are not met, the associated optimizations may be repeated. If all constraints are met, method 200 proceeds to operation 216 where optimization by optimizer 114 determines an optimization (e.g., a minimization) of total cost of ownership (TCO). From operation 216, method 200 proceeds to operation 218 which determines an optimization (e.g., a minimization) GHG CO₂ emissions. Some embodiments may perform a multi-objective optimization in which both TCO and GHG CO₂ are optimized. In some forms, such multi-objective optimization may be concurrent. In some forms, such multi-objective optimization may be sequential and performed in any order.

In some forms, operations 202 to 218 of method 200 may be performed simultaneously or concurrently, as opposed to sequentially. In some other forms, operations 202 to 218 of method 200 may be performed in a different sequence or other sequences as will occur to one of skill in the art with the benefit and insight of the present disclosure.

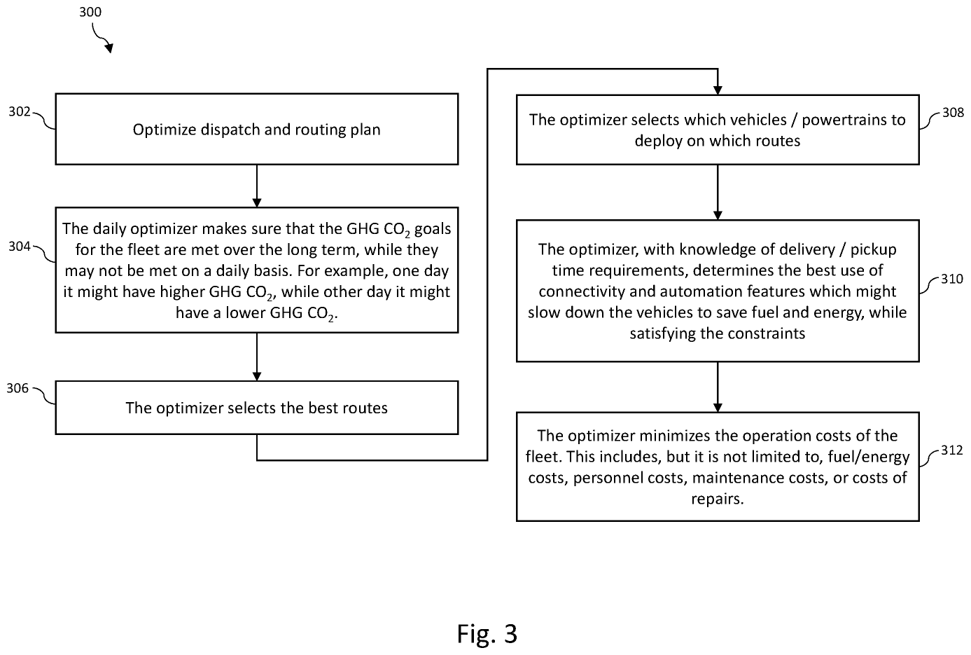

With reference to FIG. 3, there is illustrated an example method 300 which may be implemented, executed, or performed by dispatch and routing plan optimizer 114 to determine an optimized dispatch and routing plan for fleet 101 over a first time range (e.g., a daily optimization, shift or partial-day optimization, or an optimization over multiple days or multiple shifts or partial-day portions). Method 300 may begin at operation 302 which performs one or more optimizations to plan fleet operation for one day or multiple days.

From operation 302, method 300 proceeds to operation 304 which confirms that net GHG CO₂ goals for fleet 101 are met over the long term even if not met on a daily basis. For example, GHG CO₂ may be higher on one day yet lower on others.

From operation 304, method 300 proceeds to operation 306 where optimizer 114 selects the best routes for vehicles in the fleet 101.

From operation 306, method 300 proceeds to operation 308 where optimizer 114 selects which vehicles or powertrain types to deploy on which routes.

From operation 308, method 300 proceeds to operation 310 to determine, with knowledge of delivery or pickup time requirements, the best use of CAV features which might slow down vehicles in the fleet 101 to save fuel and energy, and minimize wait times, while satisfying operational constraints.

From operation 310, method 300 proceeds to operation 312 where the optimization by optimizer 114 minimizes operation costs of the fleet 101 such as, but not limited to, fuel and energy costs, personnel costs, maintenance costs, and costs of repairs.

In some forms, operations 302 to 312 of method 300 may be performed simultaneously, as opposed to sequentially. In some other forms, operations 302 to 312 of method 300 may be performed in a different sequence or other sequences as will occur to one of skill in the art with the benefit and insight of the present disclosure.

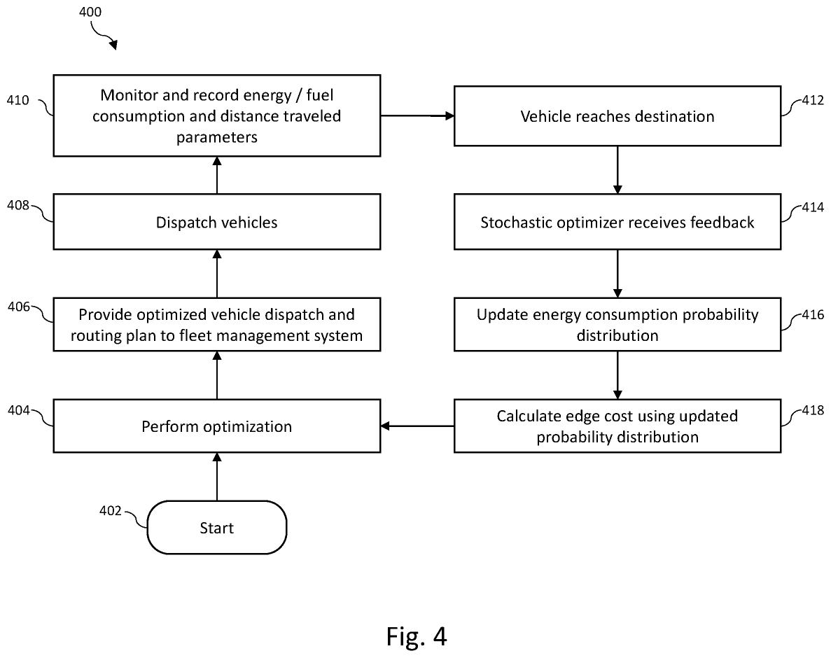

With reference to FIG. 4, there is illustrated a flow diagram depicting certain aspects of an example method 400 for operating a fleet optimization system. Method 400 begins at start operation 402 and proceeds to operation 404 which performs an optimization to determine an optimized vehicle dispatch and routing plan. In performing the optimization, operation 404 may perform or utilize operations and techniques such as those described above in connection with dispatch and routing plan optimizer 114 as well as other operations and techniques as will occur to one of skill in the art with the benefit and insight of the present disclosure.

From operation 404, method 400 proceeds to operation 406 which provides the optimized vehicle dispatch and routing plan to a fleet management system. The dispatch and routing plan may include parameters such as those described above in connection with dispatch and routing plan 120 or other parameters as will occur to one of skill in the art with the benefit and insight of the present disclosure. The fleet management system may be configured as fleet management system 124 described above or according to other fleet management systems as will occur to one of skill in the art with the benefit and insight of the present disclosure.

From operation 406, method 400 proceeds to operation 408 at which the fleet management system dispatches vehicles in fleet 101 according to the optimized vehicle dispatch and routing plan provided to the fleet management system. Thereafter the dispatched vehicles will operate according to the optimized vehicle dispatch and routing plan to the extent practicable and may vary from the optimized vehicle dispatch and routing plan, for example, if such variation is necessary or desirable in response to environmental, road, traffic, or other conditions encountered by the vehicles of the fleet.

From operation 408, method 400 proceeds to operation 410 at which energy/fuel consumption and distance traveled parameters for each vehicle of the fleet are monitored and recorded. Such monitoring and recording may occur for each vehicle until that vehicle has reached its destination which is indicated by operation 412. During operations 410 and 412, feedback parameters of each vehicle may be provided from vehicles in a vehicle fleet via one or more telematics systems, such as telematics systems 128. Such feedback parameters may include vehicle energy use parameters, for example, a number of feedback parameters including, for example, WTW GHG CO₂ tons/mile, trip success or failure, stops per mile, average speed, energy/fuel consumption, and operational cost, which may be post-calculated rather than being determined on-board vehicles of the fleet.

From operation 412, method 400 proceeds to operation 414 where a stochastic optimizer has received feedback parameters transmitted during operation 110 and/or operation 412 indicating, for example, the energy/fuel consumption of the fleet 101 operating according to the dispatch and routing plan to stochastic optimizer 118. The stochastic optimizer 118 determines updates to or modifications to one or more energy/fuel consumption, cost, or other probability distributions which are updated or modified at operation 416. At operation 418 the one or more updated energy/fuel consumption, cost, or other probability distributions are utilized by an optimizer, such as optimizer 114, to perform an optimization of an objective function including a plurality of objectives including delivery objectives and energy/fuel consumption objectives, such as the optimization described in connection with optimizer 114.

Additionally or alternatively, the one or more updated energy/fuel consumption and/or cost probability distributions, among others, may be utilized by an optimizer, such as fleet resource plan optimizer 116, to perform an optimization of an objective function including one or more fleet cost objectives, for example, total cost of ownership, vehicle cost, and/or cost of operation of the fleet, such as the optimization described in connection with optimizer 116.

As illustrated by this detailed description, the present disclosure contemplates numerous embodiments, several examples of which shall now be further elucidated. A first example embodiment is a method of operating a fleet optimization system to optimize operation of a fleet of vehicles, the method comprising: determining a dispatch and routing plan for a fleet of vehicles, the dispatch and routing plan optimizing a plurality of objectives including delivery objectives and energy/fuel consumption objectives; providing the dispatch and routing plan to a fleet management system; receiving feedback parameters indicating an energy/fuel consumption of the fleet operating according to the dispatch and routing plan; determining an energy/fuel consumption probability distribution for the fleet in response to the feedback parameters; and determining using the energy/fuel consumption probability distribution an updated dispatch and routing plan for the fleet of vehicles, the updated dispatch and routing plan optimizing the plurality of objectives.

A second example embodiment includes the features of the first example embodiment and comprises determining a fleet resource plan for the fleet of vehicles, the fleet resource plan defining a number of vehicles of the fleet and powertrain attributes of said vehicles.

A third example embodiment includes the features of the second example embodiment, wherein the act of determining the dispatch and routing plan is performed by a first optimizer configured over a first time range and the act of determining a fleet resource plan is performed by a second optimizer over a second time range greater than the first time range.

A fourth example embodiment includes the features of the third example embodiment, wherein at least one of (a) the first time range is weekly or more frequently, and (b) the second time range is monthly or less frequently.

A fifth example embodiment includes the features of the first example embodiment, wherein the feedback parameters indicate route travel parameters of the fleet operating according to the dispatch and routing plan.

A sixth example embodiment includes the features of the fifth example embodiment, wherein the route travel parameters of the fleet include actual routes traveled by vehicles of the fleet and an indication of success or failure of missions corresponding to the actual routes traveled.

A seventh example embodiment includes the features of the second example embodiment, wherein the act of determining the fleet resource plan includes determining the number of vehicles in the fleet and the powertrain attributes of said vehicles to optimize a second plurality of objectives including one or more of total operational cost of the fleet and total productivity of the fleet.

An eighth example embodiment includes the features of the second example embodiment, wherein the act of determining the fleet resource plan includes determining at least one of connectivity and automation features for vehicles in the fleet and tire attributes for vehicles in the fleet.

A ninth example embodiment includes the features of the first example embodiment, wherein the act of determining the dispatch and routing plan accounts for one or more of energy resource infrastructure parameters, vehicle powertrain parameters, and vehicle delivery loads.

A tenth example embodiment includes the features of the first example embodiment, wherein the act of determining an energy/fuel consumption probability distribution for the fleet in response to the feedback parameters is performed by a stochastic optimizer.

An eleventh example embodiment is a system for optimizing operation of a fleet of vehicles, the system comprising: an optimization network including at least one optimizer configured to execute instructions stored on one or more non-transitory memory media to determine a dispatch and routing plan for a fleet of vehicles, the dispatch and routing plan optimizing a plurality of objectives including delivery objectives and energy/fuel consumption objectives; provide the dispatch and routing plan to a fleet management system; receive feedback parameters indicating energy/fuel consumption of the fleet operating according to the dispatch and routing plan, and determine an energy/fuel consumption probability distribution for the fleet in response to the feedback parameters; and determine using the energy/fuel consumption probability distribution an updated dispatch and routing plan for the fleet of vehicles, the updated dispatch and routing plan optimizing the plurality of objectives.

A twelfth example embodiment includes the features of the eleventh example embodiment, wherein the optimization network is configured to determine a fleet resource plan for the fleet of vehicles, the fleet resource plan defining a number of vehicles of the fleet and powertrain attributes of said vehicles.

A thirteenth example embodiment includes the features of the twelfth example embodiment, wherein the optimization network is configured to determine the dispatch and routing plan using a first optimizer configured over a first time range and is configured to determine the fleet resource plan is performed using a second optimizer over a second time range greater than the first time range.

A fourteenth example embodiment includes the features of the thirteenth example embodiment, wherein at least one of (a) the first time range is weekly or more frequently, and (b) the second time range is monthly or less frequently.

A fifteenth example embodiment includes the features of the eleventh example embodiment, wherein the feedback parameters indicate route travel parameters of the fleet operating according to the dispatch and routing plan.

A sixteenth example embodiment includes the features of the fifteenth example embodiment, wherein the route travel parameters of the fleet include actual routes traveled by vehicles of the fleet and an indication of success or failure of missions corresponding to the actual routes traveled.

A seventeenth example embodiment includes the features of the twelfth example embodiment, wherein the optimization network is configured to determine by determining the number of vehicles in the fleet and the powertrain attributes of said vehicles to optimize a second plurality of objectives including one or more of total operational cost of the fleet and total productivity of the fleet.

An eighteenth example embodiment includes the features of the eleventh example embodiment, wherein the optimization network is configured to determine the fleet resource plan by determining at least one of connectivity and automation features for vehicles in the fleet and tire attributes for vehicles in the fleet.

A nineteenth example embodiment includes the features of the eleventh example embodiment, wherein the optimization network is configured to determine the dispatch and routing plan by accounting for one or more of energy resource infrastructure parameters, vehicle powertrain parameters, and vehicle delivery loads.

A twentieth example embodiment includes the features of the eleventh example embodiment, wherein the optimization network is configured to determine the energy consumption probability distribution for the fleet in response to the feedback parameters is performed by a stochastic optimizer.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A method of operating a fleet optimization system to optimize operation of a fleet of vehicles, the method comprising:
determining a dispatch and routing plan for a fleet of vehicles, the dispatch and routing plan optimizing a plurality of objectives including delivery objectives and energy/fuel consumption objectives;
providing the dispatch and routing plan to a fleet management system;
receiving feedback parameters indicating an energy/fuel consumption of the fleet operating according to the dispatch and routing plan;
determining an energy/fuel consumption probability distribution for the fleet in response to the feedback parameters; and
determining using the energy/fuel consumption probability distribution an updated dispatch and routing plan for the fleet of vehicles, the updated dispatch and routing plan optimizing the plurality of objectives.

2. The method of claim 1, comprising determining a fleet resource plan for the fleet of vehicles, the fleet resource plan defining a number of vehicles of the fleet and powertrain attributes of said vehicles.

3. The method of claim 2, wherein the act of determining the dispatch and routing plan is performed by a first optimizer configured over a first time range and the act of determining a fleet resource plan is performed by a second optimizer over a second time range greater than the first time range.

4. The method of claim 3, wherein at least one of (a) the first time range is weekly or more frequently, and (b) the second time range is monthly or less frequently.

5. The method of claim 1, wherein the feedback parameters indicate route travel parameters of the fleet operating according to the dispatch and routing plan.

6. The method of claim 5, wherein the route travel parameters of the fleet include actual routes traveled by vehicles of the fleet and an indication of success or failure of missions corresponding to the actual routes traveled.

7. The method of claim 2, wherein the act of determining the fleet resource plan includes determining the number of vehicles in the fleet and the powertrain attributes of said vehicles to optimize a second plurality of objectives including one or more of total operational cost of the fleet and total productivity of the fleet.

8. The method of claim 2, wherein the act of determining the fleet resource plan includes determining at least one of connectivity and automation features for vehicles in the fleet and tire attributes for vehicles in the fleet.

9. The method of claim 1, wherein the act of determining the dispatch and routing plan accounts for one or more of energy resource infrastructure parameters, vehicle powertrain parameters, and vehicle delivery loads.

10. The method of claim 1, wherein the act of determining an energy/fuel consumption probability distribution for the fleet in response to the feedback parameters is performed by a stochastic optimizer.

11. A system for optimizing operation of a fleet of vehicles, the system comprising:
an optimization network including at least one optimizer configured to execute instructions stored on one or more non-transitory memory media to
determine a dispatch and routing plan for a fleet of vehicles, the dispatch and routing plan optimizing a plurality of objectives including delivery objectives and energy/fuel consumption objectives;
provide the dispatch and routing plan to a fleet management system;
receive feedback parameters indicating energy/fuel consumption of the fleet operating according to the dispatch and routing plan;
determine an energy/fuel consumption probability distribution for the fleet in response to the feedback parameters; and
determine using the energy/fuel consumption probability distribution an updated dispatch and routing plan for the fleet of vehicles, the updated dispatch and routing plan optimizing the plurality of objectives.

12. The system of claim 11, wherein the optimization network is configured to determine a fleet resource plan for the fleet of vehicles, the fleet resource plan defining a number of vehicles of the fleet and powertrain attributes of said vehicles.

13. The system of claim 12, wherein the optimization network is configured to determine the dispatch and routing plan using a first optimizer configured over a first time range and is configured to determine the fleet resource plan is performed using a second optimizer over a second time range greater than the first time range.

14. The system of claim 13, wherein at least one of (a) the first time range is weekly or more frequently, and (b) the second time range is monthly or less frequently.

15. The system of claim 11, wherein the feedback parameters indicate route travel parameters of the fleet operating according to the dispatch and routing plan.

16. The system of claim 15, wherein the route travel parameters of the fleet include actual routes traveled by vehicles of the fleet and an indication of success or failure of missions corresponding to the actual routes traveled.

17. The system of claim 12, wherein the optimization network is configured to determine by determining the number of vehicles in the fleet and the powertrain attributes of said vehicles to optimize a second plurality of objectives including one or more of total operational cost of the fleet and total productivity of the fleet.

18. The system of claim 11, wherein the optimization network is configured to determine the fleet resource plan by determining at least one of connectivity and automation features for vehicles in the fleet and tire attributes for vehicles in the fleet.

19. The system of claim 11, wherein the optimization network is configured to determine the dispatch and routing plan by accounting for one or more of energy resource infrastructure parameters, vehicle powertrain parameters, and vehicle delivery loads.

20. The system of claim 11, wherein the optimization network is configured to determine the energy/fuel consumption probability distribution for the fleet in response to the feedback parameters is performed by a stochastic optimizer.
